(19) United States
(12) Patent Application Publication
(10) Pub. No.: US 2005/0248527 A1
(43) Pub. Date: Nov. 10, 2005

(54) Symbol views

(75) Inventor: Sherryl Lee Lorraine Scott, Toronto (CA)

Correspondence Address: OGILVY RENAULT LLP, 1981 MCGILL COLLEGE AVENUE, SUITE 1600, MONTREAL, QC, H3A2Y3, CA

(73) Assignee: Research In Motion Limited, Waterloo (CA)

(21) Appl. No.: 10/954,267

(22) Filed: Oct. 1, 2004

Related U.S. Application Data
(60) Provisional application No. 60/568,703, filed on May 7, 2004.

(51) Int. Cl. G06F 17/00

(52) U.S. Cl. 345/156; 345/172; 715/864

(57) ABSTRACT

A graphical user interface for inputting symbols into a handheld mobile communication device having a reduced key keyboard is disclosed. The reduced key keyboard includes a plurality of multi-functional keys and corresponding indicia including keys associated with alphabetic characters corresponding to an array of letters A-Z defined with reference to a standard alphabetic format for arranging said letters on a regular keyboard and an overlaid numeric phone key arrangement, said plurality of keys associated with alphabetic characters numbering fewer than 26. The graphical user interface (GUI) comprises a plurality of views for displaying on a display of the device, each view representing said plurality of keys associated with the alphabetic characters and respective symbols associated with individual ones of said plurality of keys; and a mapping component for selecting a symbol in response to a user input using a one of said plurality of keys associated with the alphabetic characters. Preferably, each of the plurality of views represents a look of the reduced key keyboard whereby to permit a user to visually map each key to its' associated symbol. The symbols are arranged among the plurality of views and within a view to facilitate intuitive and efficient input of the symbols.

### FIELD

This technology relates to controlling an electronic device having a keyboard. In particular, the technology concerns a user interface of symbol views for a handheld mobile communication device.

### BACKGROUND

Handheld mobile communication devices typically include a keyboard/key pad input device for inputting phone numbers, text, commands and the like to control the device. Typically, mobile communication devices have a reduced key keyboard with fewer keys than a standard keyboard for a computing device such as a laptop, personal computer, workstation, terminal and the like. In fact, to facilitate the miniaturization of handheld mobile communication devices, the 26 Latin alphabetic and 10 Arabic numeric characters may be mapped to fewer than 26 keys. Thus, an individual key may function to input one of a plurality of alphanumeric characters. In addition to alphabetic and numeric character input, the mobile communication device must permit punctuation and other symbols (e.g. “@”, “%”, “&”, “*”, “$”, etc.) to be input particularly when composing text messages such as electronic mail, Short Message Service (SMS) and Instant Message (IM) messages for sending using the mobile communication device. Often many of such punctuation and other symbols (hereinafter “symbols”) are not assigned to individual keys of the keyboard/key pad as they may be with a standard keyboard.

One manner of facilitating the inputting of symbols is to provide a symbol view on a display of the mobile communication device. The symbol view may be activated by an input device (e.g. a keyboard key) to facilitate the choice of a symbol to be input. The symbol view presents an array or other arrangement of symbols that may be selected by moving a cursor through the array to the desired symbol or that may be mapped to keys of the keyboard for selection.

FIG. 1 illustrates a symbol view 100 in accordance with a prior art mobile communication device 200 that incorporates a combined alphabetic/numeric keyboard, namely the RIM Blackberry 6210 mobile communication device. This device 200 utilizes numeric characters in a numeric phone key arrangement consistent with ITU Standard E.161, entitled “Arrangement of Digits, Letters, and Symbols on Telephones and Other Devices That Can Be Used for Gaining Access to a Telephone Network.” This standard is also known as ANSI TI.703-1995/1999 and ISO/IEC 9995-8:1994. The numeric characters share keys with alphabetic characters on the left side of the keyboard.

Device 200 utilizes a QWERTY keyboard 202 common for English-language composition wherein each of the 26 letters of the Latin alphabet are mapped to individual keys in an arrangement that corresponds to a standard QWERTY layout of alphabetic keys. The symbol view 100 comprises three rows of symbols 104 interlaced with corresponding rows 106 of alphabetic characters set out in the QWERTY layout. The symbol view may be activated during text composition by a key (e.g. “sym” 204) of the keyboard. An individual symbol from the view 100 may be input into the text from the view by pressing the corresponding keyboard key shown in the symbol view 100 or by navigating the symbols, moving a cursor over the symbols using an input device such as a thumb wheel, direction keys etc. Once a specific symbol is highlighted (e.g. “%” symbol 108), as an alternative to pressing the mapped keyboard key, the user's choice may be selected through the view 100 using a selection key (e.g. one or the other of a “space” key or “enter” key, etc.) or other input device (e.g. thumb wheel click). Moving a cursor about the view is more time consuming and requires additional user effort than pressing a mapped key.

A regular keyboard having 26 alphabetic keys provides a relatively large number of keys with which to map symbols for input. A single click of a sym key brings up as many as 26 choices for symbol inputs. Reduced key keyboard devices present fewer keys with which to map symbols and there are often more symbols than keys.

Users desire a highly functional mobile communication device that is intuitive to operate. Designing a keyboard and complimentary graphical user interface for inputting text thus presents a challenge particularly when the keyboard has relatively few keys with which to map symbols.

### SUMMARY

In accordance with the teachings described herein, there is provided a graphical user interface for inputting symbols into a handheld mobile communication device having a reduced key keyboard comprising a plurality of multi-functional keys and corresponding indicia including keys associated with alphabetic characters corresponding to an array of letters A-Z defined with reference to a standard alphabetic format for arranging said letters on a regular keyboard (e.g. QWERTY) and an overlaid numeric phone key arrangement, said plurality of keys associated with alphabetic characters numbering fewer than 26. The graphical user interface (GUI) comprises a plurality of views for displaying on a display of the device, each view representing said plurality of keys associated with the alphabetic characters and respective symbols associated with individual ones of said plurality of keys; and a mapping component for selecting a symbol in response to a user input using a one of said plurality of keys associated with the alphabetic characters.

Preferably, each of the plurality of views represents a look of the reduced key keyboard whereby to permit a user to visually map each key to its' associated symbol. The symbols may be arranged among the plurality of views and within a view to facilitate intuitive and efficient input of the symbols. Persons of ordinary skill in the art will appreciate that further aspects of the invention include a method aspect, a handheld mobile communication device aspect and a computer program product aspect, among others.

### BRIEF DESCRIPTION OF THE DRAWING FIGURES

FIG. 1 is a schematic view of a portion of a display of a handheld mobile communication device showing a symbol view of a graphical user interface in accordance with the prior art;

FIG. 2 is an elevated view of a prior art handheld mobile communication device incorporating a standard QWERTY alphabetic format with a numeric key arrangement overlaid on a portion of the QWERTY alphabetic keys;

FIG. 3 is an elevated view of a handheld mobile communication device having an example keyboard incorporating a preferred reduced key keyboard arrangement;

FIG. 4 is an exploded view of an alternate reduced key keyboard for the mobile communication device of FIG. 3;

FIG. 5 is a front view of a handheld device incorporating an example keyboard arrangement without punctuation;

FIG. 6 is another example keyboard arrangement for a reduced key QWERTY/numeric keyboard;

FIG. 7 is an alternative example keyboard arrangement for a reduced key QWERTY/numeric keyboard;

FIG. 8 is an example keyboard arrangement for a reduced key QWERTZ/numeric keyboard;

FIG. 9 is an example keyboard arrangement for a reduced key AZERTY/numeric keyboard;

FIGS. 10-12 are schematic views of a portion of a display of a handheld mobile communication device showing three respective symbol views (1/3, 2/3 and 3/3 respectively) of a graphical user interface in accordance with an embodiment of the invention;

FIG. 13 is a flowchart of operations for a graphical user interface including the views of FIGS. 10-12; and

FIG. 14 is a block diagram illustrating an example mobile communication device.

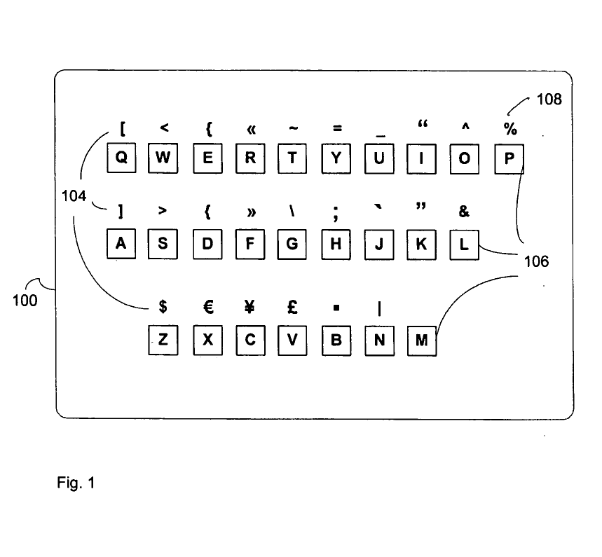

### DETAILED DESCRIPTION

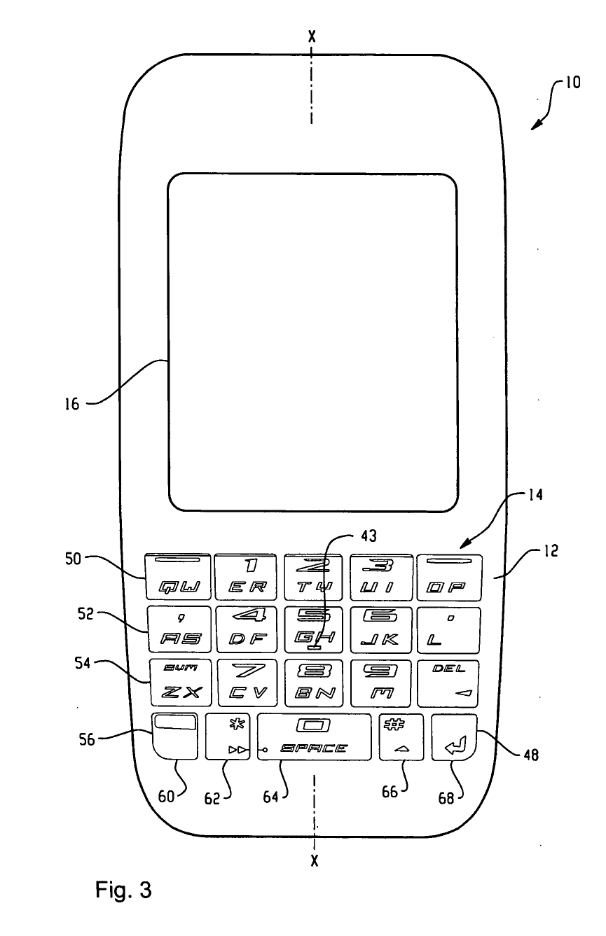

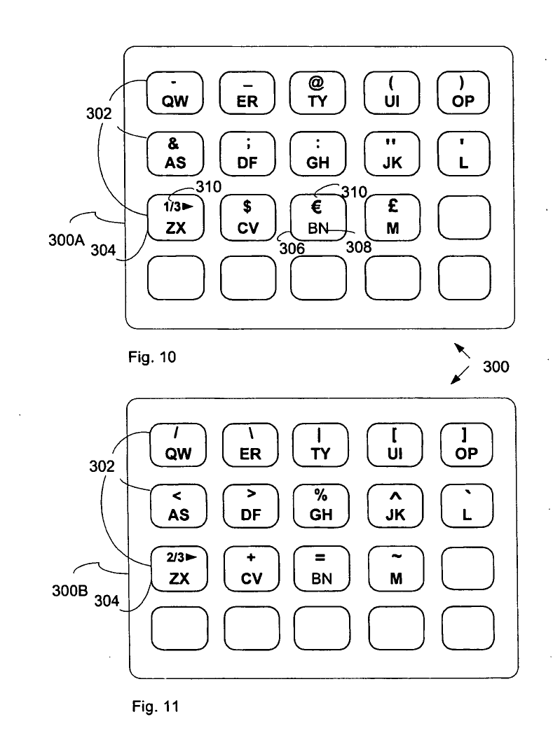

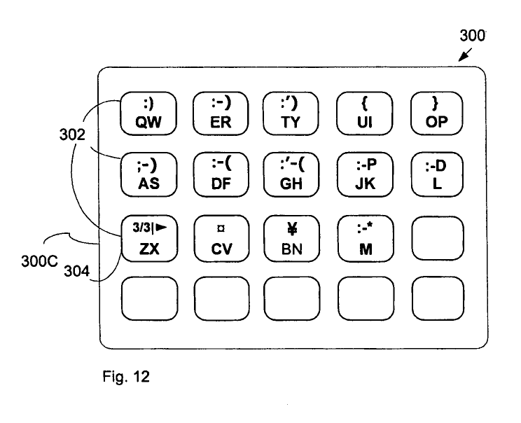

A graphical user interface (GUI) for inputting symbols to a handheld mobile communication device having a reduced key keyboard is described. FIGS. 3-9 illustrate examples of reduced key keyboards and FIGS. 10-13 illustrate a GUI including exemplary symbol views and operations for inputting symbols using a reduced key keyboard.

With reference now to the drawings, FIGS. 3-9 include various views of a mobile communication device 10 having an example keyboard 14. The keyboard 14 is a physical keyboard that includes a plurality of multi-functional keys. The keys are multi-functional in that they may be used to enter alphabetic characters, numbers, touch tones, symbols, and/or functions, or other known entries. The keyboard is a physical keyboard in the sense that it utilizes keys that are movable, rather than a touch screen-type keyboard, which does not utilize movable keys. In a preferred embodiment, the keys are movable to activate switches that are positioned beneath the keys.

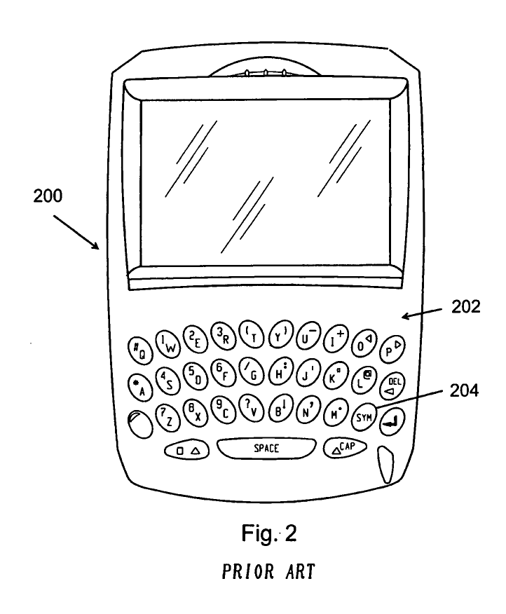

The example physical keyboard 14 may be used for text entry and telephony entry and is intended to marry well known keyboards (e.g. QWERTY), such as those used on computer or typewriter keyboards, with keypads, such as those used on touch tone phones or cellular phones, into a single arrangement. The example physical keyboard is designed to be readily familiar to a user because of this marriage. The keyboard 14 provides a first user interface that includes alphabetic characters 44 comprising a standard alphabetic format, such as QWERTY, QWERTZ, AZERTY (shown), or DVORAK (not shown), among other known formats, for text entry, and a second user interface that includes numeric characters for telephony entry. Current standard alphabetic keyboard formats utilize 26 keys for alphabetic characters, as shown in FIG. 2, with each key representing a single alphabetic character. A preferred embodiment of the example keyboard 14 presents alphabetic characters in a reduced key format, with fewer columns and keys than the standard format. Each of the 26 alphabetic characters are provided, but in a reduced format such that some of the keys of the keyboard represent more than one alphabetic character. The alphabetic characters, numbers, symbols, and functions are represented on the keyboard 14 by indicia, which may be positioned directly on the keys of keyboard 14, or positioned on the housing of the mobile communication device.

The preferred reduced physical keyboard is accomplished by utilizing fewer columns than a standard format keyboard. Because of this, the keyboard 14 is well suited for application on a housing form factor similar to that of a housing associated with a numeric-keypad-based mobile communication device. In particular, the reduced column keyboard 14 provides for reduced size devices without sacrificing speed and convenience to a user. The reduced key keyboard also allows for smaller devices that are more stylish and fashionable.

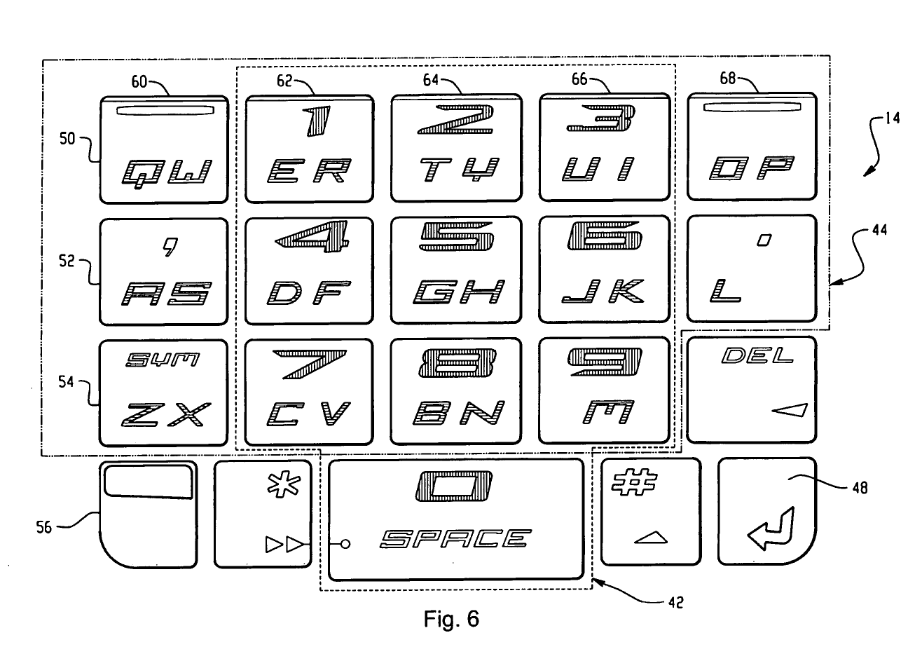

The second user interface of the example keyboard 14 includes numeric characters that correspond to a phone pad 42, including the numbers 0-9. It is preferred that the array of numbers be presented on the keyboard in the format of a standard numeric phone key arrangement 42, depicted in FIG. 6, such that the numbers “1, 2, 3” appear in the first row 50, “4, 5, 6” appear in the second row 52, “7, 8, 9” appear in the third row 54, and at least a “0” appears in the fourth, bottom row 56, with each row of numbers being symmetrical about a common center line that runs through the center column of numbers. It is preferred that the “0” be centered beneath the remainder of the numbers 1-9. In addition, each number is positioned on its own key, as with a standard phone key pad. The standard numeric phone key arrangement corresponds to the International Telecommunication Union (“ITU”) Standard E.161, entitled “Arrangement of Digits, Letters, and Symbols on Telephones and Other Devices That Can Be Used for Gaining Access to a Telephone Network” (also known as ANSI TI.703-1995/1999 and ISO/IEC 9995-8:1994).

The fourth row 56 may also include the symbols “*” and “#”, although these symbols may alternatively be positioned at other locations on the keyboard 14 (not shown), or appear on the display of the mobile communication device when invoked by a symbol view lookup as described further below with reference to FIGS. 10 to 13. In a preferred embodiment, the “*” key is positioned directly to the left of the “0” key and the “#” key is positioned directly to the right of the “0” key. In any case, the “*” and “#” keys preferably do not share keys with any of the numbers 0-9.

Though not shown, the numeric key arrangement need not correspond to the ITU E.161 standard and may be arranged as typically arranged on a standard typewriter keyboard that has a numeric keypad spaced from the alphabetic characters.

The keyboard 14 may further include selected symbols and functions that are typically utilized with keyboards. Example symbols that may be selected include “.”, “,”, “;”, ““”, “””, “:”, “?”, “/”, “>”, “<”, “!”, “@”, .“˜”, “$”, “%”, “\hat{ }”, “&”, “(”, “)”, “_”, “−”, “+”, “=”, “[”, “]”, “{”, “}”, “|”, and “\”, among other known symbols. However, in accordance with embodiments of the invention, a GUI is provided for inputting such symbols. Example functions include “tab”, “caps lock”, “shift”, “control”, “alt”, “return/enter”, “backspace”, “insert”, “delete”, “home”, “end”, “page up”, “page down”, “end”, “escape”, “pause”, “break”, “send”, “end”, “txt”, “sym”, and “scroll lock”, among other known functions associated with text entry or telephony entry. As illustrated, FIG. 3 shows a “,” associated with key “AS” and a “.” associated with key “L”. In an alternative embodiment (not shown), key “AS” is associated with a “?”, key “L” with a “,”, key QW with a “!” and key “OP” with a “.”.

The keys on the physical keyboard 14 that are associated with numbers may be used in both text mode and in telephony mode. The keyboard 14 may include a mode selection key, or other hardware or software for switching between text entry (the first user interface) and telephony entry (the second user interface). In a telephone number composition dialog (e.g. when making an outgoing call) the telephony entry mode may be a default mode. The telephony characters may be input when the mobile communication device 10 is in telephony or text-entry mode, and the text-entry characters may be input when the mobile communication device 10 is in text-entry mode. The functional keys may also be configured to operate in both the telephony mode and the text-entry mode, or, alternatively, one or more of the functional keys may be operable in only the telephony mode or the text-entry mode. In this manner, the keyboard 14 has at least two distinct ergonomic configurations depending upon the mode of the mobile communication device 10. Also, the keyboard design results in at least two distinct, but familiar user interfaces that the user has likely had experience using separately on two distinct devices (e.g. a telephone and a computer). In each of the reduced format keyboards 14 discussed herein, the selection of a particular character, number, symbol, or function may be derived from predictive text software residing on the mobile communication device and/or from multiple switches associated with the keys, as discussed in greater detail below.

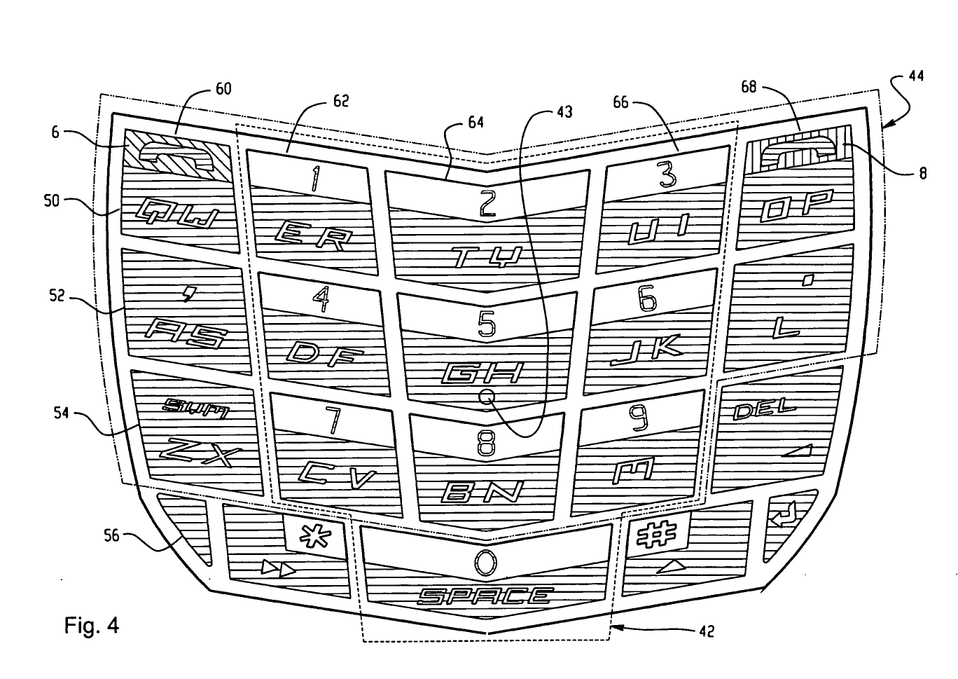

Referring again to the drawings, FIG. 3 shows a handheld mobile communication device 10 that has an example physical keyboard array of twenty keys, with five columns and four rows. Fourteen keys are used for alphabetic characters and ten keys are used for numbers. Nine of the ten numbers share a key with alphabetic characters. The “space” key and the number “0” share the same key, which is centered on the device and centered below the remainder of the numbers on the keyboard 14. The four rows include a first row 50, a second row 52, a third row 54, and a fourth row 56. The five columns include a first column 60, a second column 62, a third column 64, a fourth column 66, and a fifth column 68. Each of the keys in the first row 50, second row 52, and third row 54 is uniformly sized while the keys in the fourth, bottom row 56 have different sizes relative to one another and to the keys in the first three rows 50, 52, 54. The rows and columns are straight, although the keys in the fourth row 56 do not align completely with the columns because of their differing sizes. The columns substantially align with the longitudinal axis x-x of the device 10. In another embodiment of this example keyboard array, such as that shown in FIG. 4, the rows and/or columns need not be straight.

An exploded view of a keyboard for a handheld mobile communication device 10 that has an example physical keyboard array of 20 keys, with five columns and four rows is presented in FIG. 4. Fourteen keys on the keyboard 14 are associated with alphabetic characters and ten keys are associated with numbers. The four rows include a first row 50, a second row 52, a third row 54, and a fourth row 56. The five columns include a first column 60, a second column 62, a third column 64, a fourth column 66, and a fifth column 68. Many of the keys have different sizes than the other keys, and the rows are non-linear. In particular, the rows are V-shaped, with the middle key in the third column 64 representing the point of the V. The columns are generally straight, but the outer two columns 60, 62, 66, 68 angle inwardly toward the middle column 64. To readily identify the phone user interface (the second user interface), the numeric phone keys 0-9 include a color scheme that is different from that of the remaining keys associated with the QWERTY key arrangement. The “send” key 6 is positioned in the upper left corner of the keyboard 14 and the “end” key 8 is positioned in the upper right corner. The “send” key 6 and “end” key 8 may have different color schemes than the remainder of the keys in order to distinguish them from other keys. In addition, the “send” and “end” keys 6, 8 may have different colors from one another. In the example shown, the “send” key 6 is green and the “end” key 8 is red. Different colors may be utilized, if desired.

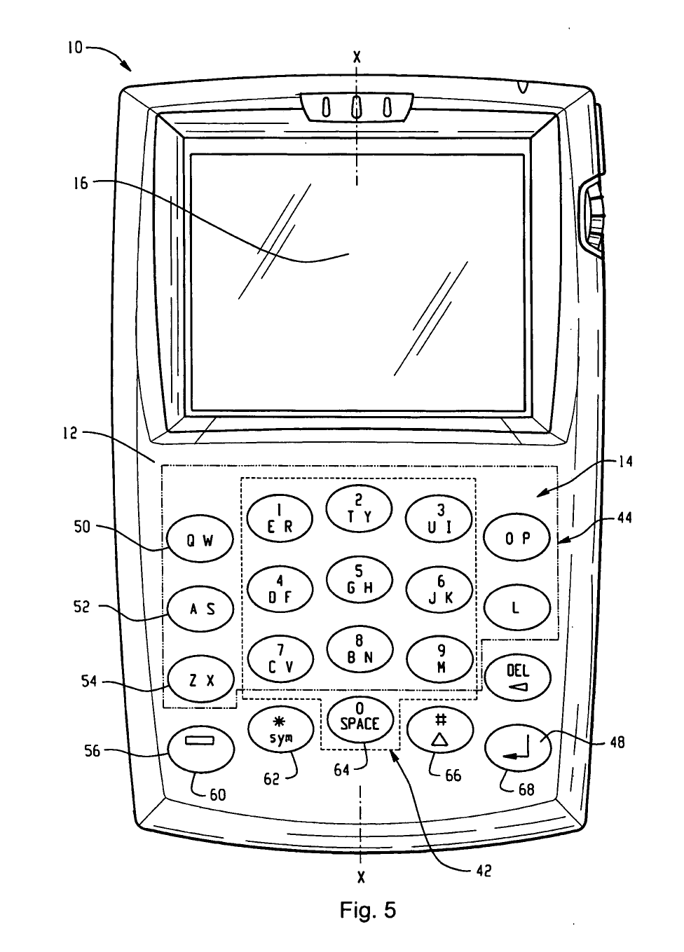

FIG. 5 depicts a handheld mobile communication device 10 similar to FIG. 3, but with a different key arrangement. In this embodiment, a 20 key array is provided in five columns and four rows. Fourteen keys are associated with alphabetic characters 44 and ten keys are associated with numbers 42. The four rows include a first row 50, a second row 52, a third row 54, and a fourth row 56. The five columns include a first column 60, a second column 62, a third column 64, a fourth column 66, and a fifth column 68. The rows are arcuately shaped, with the upper most part of the arc being in the center column 64. Each of the columns is straight and substantially aligned with a longitudinal axis X-X of the device 10. The keys are oval shaped and multi-functional. The phone pad numbers 42 are overlaid on and associated with some of the same keys as keys that are associated with the alphabetic characters 44. Nine of the ten numbers share keys with alphabetic characters. In a preferred embodiment, the phone numbers 0-9 are centered on the alphabetic character key arrangement 44. The “space” bar coincides with the number “0” and is centered in the third column 64 of the fourth row 56.

FIGS. 6-9 depict various key configurations for the physical keyboard array shown in FIGS. 3 and 5, which utilizes five columns and four rows to represent a reduced column QWERTY keyboard with an overlaid numeric phone key arrangement 42. The four rows include a first row 50, a second row 52, a third row 54, and a fourth row 56. The five columns include a first column 60, a second column 62, a third column 64, a fourth column 66, and a fifth column 68.

FIG. 6 depicts a twenty key physical keyboard 14 where the numeric phone key arrangement 42 is centered between the five columns. The first row 50 of keys includes in order the following key combinations for the text entry and telephony mode: “QW”, “ER/1”, “TY/2”, “UI/3”, and “OP”. The second row 52 includes the following key combinations in order: “AS/,”, “DF/4”, “GH/5”, “JK/6”, and “L/.”. The third row 54 includes the following key combinations in order: “ZX/sym”, “CV/7”, “BN/8”, “M/9” and “backspace/delete.” The “sym” function key pulls up a plurality of symbols that the user may select to input as described below. The fourth row 56 includes the following key combinations in order: “alt”, “next/*”, “space/O”, “shift/#”, and “return/enter”. The keys in the top three rows 50, 52, 54 are of uniform size while the keys in the fourth row 56 have a size that is different from the keys in the top three rows. In particular, the center “space” key 84 is larger than the other four keys in the row, with the other four keys having a similar size. The outermost keys in the fourth row 56 also have a more rounded shape, for aesthetic and other reasons. Each of the rows is straight and each of the columns is straight, with the keys in the fourth row 56 being misaligned with the five columns due to their different sizes. The “0” of the numeric phone key arrangement 42 coincides with the “space” bar. In another embodiment of the fourth row 56, the center “space” key contains multiple functions, symbols, characters or numbers, such as the key combination “next/*”, “space/o”, “shift/#”, or some combination thereof. The selection of a particular function, character, symbol or number may be derived from predictive text software residing on the mobile communication device and/or multiple switches associated with the “space” key.

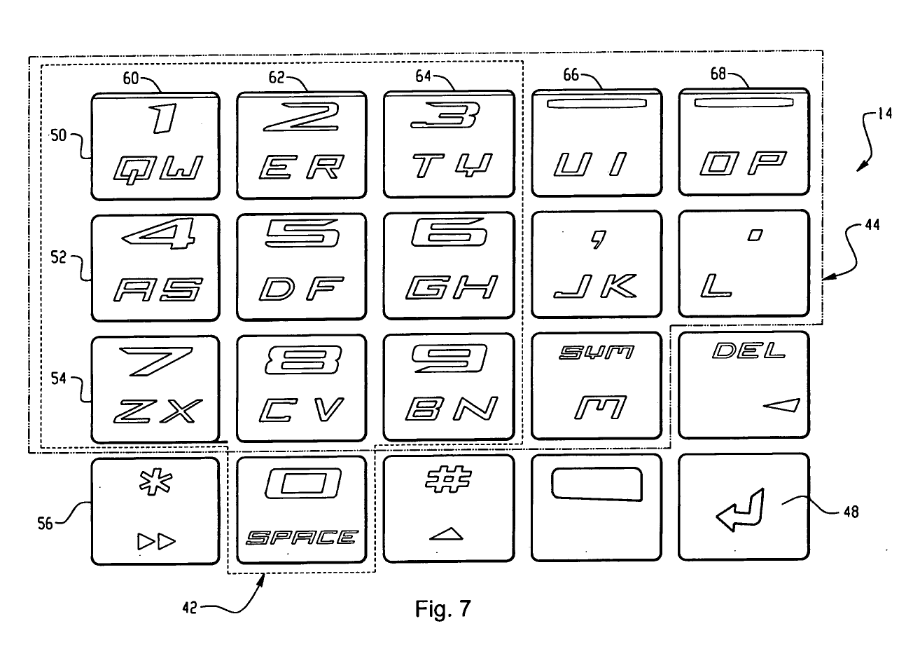

FIG. 7 shows a similar format for the reduced QWERTY arrangement of alphabetic characters 44 as presented in FIG. 22, but the numeric phone key arrangement 42 is positioned in the first 60, second 62, and third 64 columns instead of being centered on the keyboard 14. The first row 50 of keys includes in order the following key combinations for the text entry and telephony mode: “QW/1”, “ER/2”, “TY/3”, “UI”, and “OP”. The second row 52 includes the following key combinations in order: “AS/4”, “DF/5”, “GH/6”, “JK/,”, and “L/.”. The third row 54 includes the following key combinations in order: “Zx/7”, “CV/8”, “BN/9”, “M/sym” and “backspace/delete”. The fourth row 56 includes the following key combinations in order: “next/*”, “space/0”, “shift/#”, “alt” and “return/enter”. The keys in each of the rows is of uniform size and the rows and columns are straight.

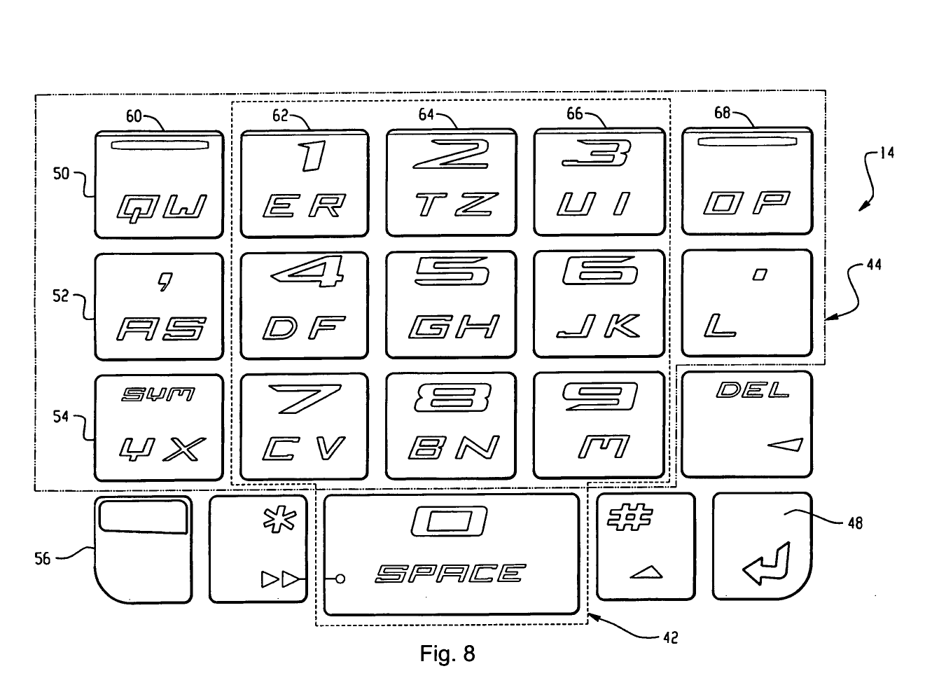

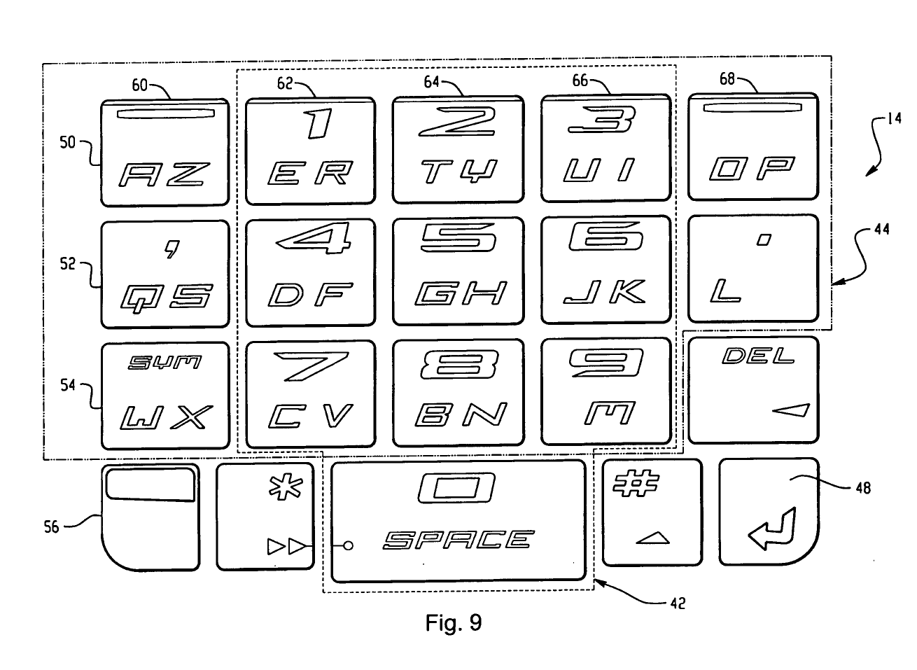

FIG. 8 shows another key arrangement similar to that shown in FIG. 6, but for a reduced QWERTZ keyboard arrangement. FIG. 9 shows a key arrangement similar to that shown in FIG. 6, but for a reduced AZERTY keyboard arrangement. In each of the embodiments described above, the return/enter key 48 is positioned in the vicinity of the right, bottom corner of the keyboard 14. In a preferred embodiment, the return/enter key 48 is positioned in the fifth column 68 or in the fourth row 56.

The physical keyboard 14 includes hardware and software associated with each of the keys for entry of a character, as indicated by indicia on or near the key, which hardware and software are well known to those skilled in the art. An example of a mobile communication device having a keyboard assembly with hardware and software associated with key entry is described in U.S. patent application Ser. Nos. 09/967,537 and 10/302,242 and U.S. Pat. No. 6,278,442, the disclosures of which are incorporated herein by reference in their entirety.

The mobile communication device 10 may also include a predictive text computer program that is used in conjunction with the keyboard. Predictive test software is useful in reduced format keyboards, such as the example keyboard, in order to identify the desired input from the combination of keystrokes of a user. A predictive text computer program may, for example, be used to predict a complete word or phrase from one or more keystrokes. If the predictive text computer program does not successfully predict a desired word or phrase, then text-entry characters may be entered more precisely, albeit more slowly, by selecting the appropriate characters on the keys. An example predictive text computer program is described in the following co-owned patent applications, which are incorporated herein by reference in their entirety: “Customizable Predictive Text Method For Reduced Keyboards,” U.S. Provisional Patent Application No. 60/397,680, filed Jul. 23, 2002; “Systems and Methods of Building and Using Custom Word Lists,” International Patent Application No. PCT/CA03/01103, filed Jul. 23, 2003, and “Portable Electronic Device With Keyboard”, International Patent Application No. PCT/CA02/00862, filed Jun. 10, 2002.

A number of different predictive text technologies are known and may be utilized with the example keyboard. In a multi-tap methodology, the user taps a key multiple times until a desired letter, number, symbol, or function is selected. This technology has been utilized on cell phones and touch screen devices, among other devices. Companies that offer solutions for the multi-tap method include Motorola (e.g., iTAP); Zi (e.g., eZiText); AOL (Tegic) (e.g., T9); and Eatoni (e.g., LetterWise). A related method is the long tap method, where a user depresses the key until the desired character appears on the display.

Another technology involves predictive text methodologies. These methodologies utilize database software to predict the entered text. One method involves automatically correcting common spelling mistakes (e.g., “teh” corrected to “the”). Predictive text methodologies use known spellings of words in combination with their probabilities and frequencies of use to determine a preferred word based upon input commands by a user. Disambiguation engines and predictive editor applications may be used to establish a single grammatical or semantic interpretation of the keystrokes entered by a user. With predictive editor applications, the display of the device depicts possible character sequences corresponding to the keystrokes that were entered. Typically, the most commonly used word is displayed first. The user may select other, less common words manually, or otherwise. Other types of predictive text computer programs may be utilized with the keyboard arrangement and keyboard described herein, without limitation.

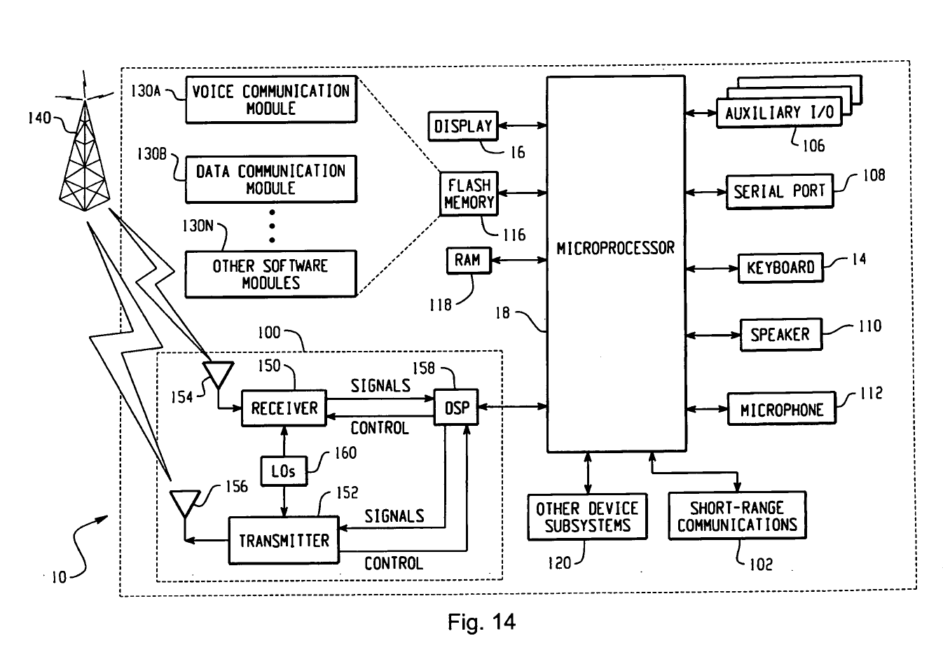

The handheld mobile communication devices 10 include similar features, such as a housing 12, a keyboard 14 and an output device 16. The output device shown is a display 16, which is preferably a full graphic LCD. Other types of output devices may alternatively be utilized. A processing device 18, which is shown schematically in FIG. 14, is contained within the housing 12 and is coupled between the physical keyboard 14 and the display 16. The processing device 18 controls the operation of the display 16, as well as the overall operation of the mobile communication device 10, in response to actuation of keys on the keyboard 14 by the user.

The housing 12 may be elongated vertically, or may take on other sizes and shapes, including a clamshell housing structure, among other structures. The keyboard may include a mode selection key, or other hardware or software for switching between text entry and telephony entry. As noted, a telephone number composition application may ensure that telephony entry is a default mode for this function.

In addition to the processing device 18, other parts of the mobile communication device 10 are shown schematically in FIG. 14. These include a communications subsystem 100; a short-range communications subsystem; the keyboard 14 and the display 16, along with other input/output devices 106, 108, 110 and 112; as well as memory devices 116, 118 and various other device subsystems 120. The mobile communication device 10 is preferably a two-way RF communication device having voice and data communication capabilities. In addition, the mobile communication device 10 preferably has the capability to communicate with other computer systems via the Internet.

Operating system software executed by the processing device 18 is preferably stored in a persistent store, such as a flash memory 116, but may be stored in other types of memory devices, such as a read only memory (ROM) or similar storage element. In addition, system software, specific device applications, or parts thereof, may be temporarily loaded into a volatile store, such as a random access memory (RAM) 118. Communication signals received by the mobile communication device may also be stored to the RAM 118.

The processing device 18, in addition to its operating system functions, enables execution of software applications 130A-130N on the device 10. A predetermined set of applications that control basic device operations, such as data and voice communications 130A and 130B, may be installed on the device 10 during manufacture. In addition, a personal information manager (PIM) application may be installed during manufacture. The PIM is preferably capable of organizing and managing data items, such as e-mail, calendar events, voice mails, appointments, and task items. The PIM application is also preferably capable of sending and receiving data items via a wireless network 140. Preferably, the PIM data items are seamlessly integrated, synchronized and updated via the wireless network 140 with the device user's corresponding data items stored or associated with a host computer system. An example system and method for accomplishing these steps is disclosed in “System And Method For Pushing Information From A Host System To A Mobile Device Having A Shared Electronic Address,” U.S. Pat. No. 6,219,694, which is owned by the assignee of the present application, and which is incorporated herein by reference.

Communication functions, including data and voice communications, are performed through the communication subsystem 100, and possibly through the short-range communications subsystem. The communication subsystem 100 includes a receiver 150, a transmitter 152, and one or more antennas 154, 156. In addition, the communication subsystem 100 also includes a processing module, such as a digital signal processor (DSP) 158, and local oscillators (LOs) 160. The specific design and implementation of the communication subsystem 100 is dependent upon the communication network in which the mobile communication device 10 is intended to operate. For example, a mobile communication device 10 may include a communication subsystem 100 designed to operate with the Mobitex™, Data TAC™ or General Packet Radio Service (GPRS) mobile data communication networks and also designed to operate with any of a variety of voice communication networks, such as AMPS, TDMA, CDMA, PCS, GSM, etc. Other types of data and voice networks, both separate and integrated, may also be utilized with the mobile communication device 10.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore requires a subscriber identity module, commonly referred to as a SIM card, in order to operate on a GPRS network.

When required network registration or activation procedures have been completed, the mobile communication device 10 may send and receive communication signals over the communication network 140. Signals received from the communication network 140 by the antenna 154 are routed to the receiver 150, which provides for signal amplification, frequency down conversion, filtering, channel selection, etc., and may also provide analog to digital conversion. Analog-to-digital conversion of the received signal allows the DSP 158 to perform more complex communication functions, such as demodulation and decoding. In a similar manner, signals to be transmitted to the network 140 are processed (e.g. modulated and encoded) by the DSP 158 and are then provided to the transmitter 152 for digital to analog conversion, frequency up conversion, filtering, amplification and transmission to the communication network 140 (or networks) via the antenna 156.

In addition to processing communication signals, the DSP 158 provides for control of the receiver 150 and the transmitter 152. For example, gains applied to communication signals in the receiver 150 and transmitter 152 may be adaptively controlled through automatic gain control algorithms implemented in the DSP 158.

In a data communication mode, a received signal, such as a text message or web page download, is processed by the communication subsystem 100 and is input to the processing device 18. The received signal is then further processed by the processing device 18 for an output to the display 16, or alternatively to some other auxiliary I/O device 106. A device user may also compose data items, such as e-mail messages, using the keyboard 14 and/or some other auxiliary I/O device 106, such as a touchpad, a rocker switch, a thumb-wheel, or some other type of input device. The composed data items may then be transmitted over the communication network 140 via the communication subsystem 100.

In a voice communication mode, overall operation of the device is substantially similar to the data communication mode, except that received signals are output to a speaker 110, and signals for transmission are generated by a microphone 112. Alternative voice or audio I/O subsystems, such as a voice message recording subsystem, may also be implemented on the device 10. In addition, the display 16 may also be utilized in voice communication mode, for example to display the identity of a calling party, the duration of a voice call, or other voice call related information.

The short-range communications subsystem enables communication between the mobile communication device 10 and other proximate systems or devices, which need not necessarily be similar devices. For example, the short-range communications subsystem may include an infrared device and associated circuits and components, or a Bluetooth™ communication module to provide for communication with similarly-enabled systems and devices.

As described above, a preferred example keyboard represents a marriage of a text entry keyboard with a telephony keypad, but in a reduced key format. The example keyboard can be used in two modes. In a first mode, the user utilizes two hands to input text characters, similar to the use of a standard 26 key keyboard. In a second mode, the user utilizes a single hand to input numeric characters in telephony mode. Thus, the example keyboard provides two different methods for input, both of which are already familiar separately to a user.

Accordingly, the example keyboard also concerns a method for operating a keyboard and for inputting text and telephony commands on a keyboard. The method includes inputting numbers into a mobile communication device utilizing a single hand and inputting text into a mobile communication device utilizing two hands. The method further includes inputting functional commands and symbols utilizing two hands. Alternatively, functional commands and symbols may be input utilizing one hand.

The keys may be toggle keys or non-toggle keys, if desired. Additional or fewer rows and columns, above and beyond the number shown herein, may also be provided to position functional and other keys, if desired. Furthermore, the keys may be aligned in columns, or may be staggered, in some embodiments.

FIGS. 10-13 illustrate respective views 1/3, 2/3 and 3/3 (respectively 300A, 300B and 300C and collectively 300) of a multiple page symbol view 300 of a GUI in accordance with an embodiment of the invention for adapting a handheld mobile communication device having a reduced key keyboard to input symbols. View 300 may be initiated in a text entry mode, for example, when composing messages, by a user using a “sym” key of the keyboard 14. In many of the keyboards 14 of FIGS. 3-7, the “sym” key is the left most key of row 54 sharing functionality with an alphabetic key of the reduced key keyboard. The “sym” key may be a non-alphabet key, such as one of the keys of row 56 as seen in FIG. 5. Though not shown, a label, such as “View 1/3”, may be displayed to indicate which of the multiple views is on the display and that additional views are available.

Each individual view 300A-300C of view 300 presents a QWERTY keyboard layout, such as is shown in FIGS. 3-7, including 3 rows of alphabetic keys 302. Each of the alphabetic keys 302 represents the respective alphabetic letter keys 44 of keyboard 14 and the respective symbol or function of the view 300 to which the keyboard key is mapped. For example, key 306 shows alphabet letters “BN” 308 and, in view 1/1 300A, the associated euro currency symbol “ [symbol] ” 310. Key 304, in the present embodiment, is a function key for view 300 and as such indicates that they key may be used to navigate to the next individual view. In view 1/3 300A, key 304 includes a function reference 310 comprising a current view indicator (“1/3”) and a direction indicator (“≃”) indicating how to move to the next view, namely, view 2/3 300B. As noted, in many of the keyboards of FIGS. 3-7, the keyboard key corresponding to view key 304 represents the “sym” key for activating view 300.

As noted previously, there are more candidate symbols than keys of a reduced key keyboard. View 300 provides a manner of mapping symbols to keyboard keys in a multiple view format which is extensible to many pages. However, the symbols are required to be mapped to the keys in a manner that provides users with desired functionality including a user experience that is intuitive and efficient. Symbols are required to be arranged relative to the keys and relative to the plurality of individual views. As well, the symbols that are most likely to be used are mapped to keys from left to right with those showing the highest expected usage mapped to keys toward the left of the keyboard 14.

View 300 provides a software extension of physical keyboard 14 and to facilitate the goals of providing an intuitive and efficient user interface for inputting symbols, view 300 is arranged to simulate, where possibly, the user experience of a regular keyboard.

When assigning symbols to the views, the following principles where considered and balanced. To facilitate a goal of efficient symbol inputs, symbols such as punctuation or other delimiters common to electronic text messaging (e.g. “@”, “_” and “&”) that are more likely to be frequently used are preferably shown on a early view such as the first view 300A. To facilitate a goal of intuitive symbol input, symbols that are generally associated with specific keys in a regular keyboard may be associated with the corresponding keys in the reduced key keyboard. For example, in a regular QWERTY keyboard, the symbol “@” is associated with the key for number “2”, the symbol “%” is associated with the key for number “5” and the symbol “\hat{ }” is associated with the key for number “6”. Thus, in views 300A and 300B these symbols are associated with the keyboard keys for inputting the respective numbers (i.e. 2=@ so 2/TY=@, 5=% so 5/GH=%, 6=\hat{ } so 6/JK=\hat{ }). Similarly, related symbols such as brackets, braces and parenthesis may be grouped and may be placed in a similar position from one view to the next. They are preferably positioned within a page of the view to correspond to the portion (e.g. right side) of the standard QWERTY keyboard where they are routinely found.

So that users may navigate the individual views to select a desired symbol, access to additional views is linked to the “sym” key and indicated in the view.

Currency symbols may be grouped in accordance with expected frequency such as dollar, euro, pound (on first view 300A) and then yen, and overall currency indicator in that order in a similar placement position (but on the third view 300C). Other symbols may be arranged where they fit in the most logical groupings and in accordance with expected frequency of punctuation usage.

Preferably, keys of keyboard 14 that have function capability within text input are not assigned symbols in view 300.

In addition to permitting the selection of a symbol through a mapped keyboard key, the GUI allows a user may navigate the view 300, moving a cursor through the keys and associated symbols. A “next” key of device 14 also the user to move forward through the symbol selections. When at the last selection of any individual symbol view, if pressed it will return to the start of the top row of the same view. The “space” key and “enter” key each selects a symbol highlighted by the cursor and this functionality is repeated in other aspects of the GUI for consistency, such as the selection of a word in the word list (not shown). An auxiliary I/O device 106 such as a thumb wheel for moving a cursor or other focus about the GUI and selecting a symbol for input may also be used.

View 300C presents composed emoticons or “smilies” commonly used in text messaging for expressing a user's emotion in a compact manner. Thus it will be recognized that a symbol to be input may comprise more than one character. alternatively, symbols may include graphical representations (e.g. “ [symbol] ” for “:)”)

Though each page of view 300 is illustrated in a relatively neutral manner, preferably, the look of the symbol view accurately represents the devices keypad so that the user can easily visually map each key to its' associated symbol.

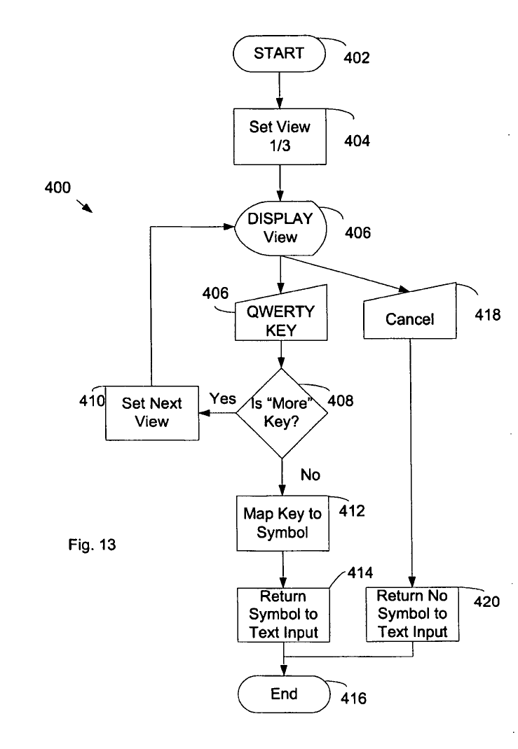

FIG. 13 illustrates a flowchart of operations 400 for presenting and responding to user interaction with views 300A, 300B and 300C in a GUI. Operations start at step 402 such as upon a user input of the “sym” key in a text mode. At step 404, initial view 1/3 300A is set as the current view and any associated mappings between the keyboard keys 44 and the symbols of the view 300A made current. At step 406, the view is displayed. The view may overlay a portion of the display 16 of the device 10 or the entire display. Steps 406 and following illustrate operations in response to a user input using an alphabetic key 44. Steps 418 and following illustrate operations should a user cancel out of the view. Not shown are operations for navigating the view using a “next” key or the like and a selection key such as “space” or “enter”, which navigations and selection operations will be well understood to persons of ordinary skill in the art. At step 406, one of alphabet keys 44 is received via keyboard 14 and at step 408 a determination is made whether it is the “more” key to move to a next view. If yes, via yes branch to step 410 the next view and mappings are initiated and operations loop to continue at step 406. If no, via No branch to step 412, the symbol associated with the keyboard key is determined according to the mapping for the individual view and the symbol is returned for including in the text being composed (step 414). Thereafter operations 400 end (step 416).

Should a user cancel out of a view (step 418) no symbol is returned for including in the text being composed (step 420) and thereafter operations 400 end (step 416).

Persons of ordinary skill in the art will appreciate that view 300 and associated operations therefor may be implemented in software for execution by microprocessor 18 of device 10. The software may be stored to flash memory 116, for example, as one or other software modules 130N.

While most of the keyboard examples and all of the view examples depict a QWERTY arrangement of alphabetic characters, the examples are equally applicable to other standard arrangements. Moreover, the QWERTY keyboard has been presented with certain combinations of alphabetic characters on each key. Other combinations may alternatively be utilized, without limitation, as long as the alphabetic characters are presented in the same order as their standard arrangement.

The word “substantially” is used herein as an estimation term.

While various features of the claimed invention are presented above, it should be understood that the features may be used singly or in any combination thereof. Therefore, the claimed invention is not to be limited to only the specific embodiments depicted herein.

Further, it should be understood that variations and modifications may occur to those skilled in the art to which the claimed invention pertains. The embodiments described herein are exemplary of the claimed invention. The disclosure may enable those skilled in the art to make and use embodiments having alternative elements that likewise correspond to the elements of the invention recited in the claims. The intended scope of the invention may thus include other embodiments that do not differ or that insubstantially differ from the literal language of the claims. The scope of the present invention is accordingly defined as set forth in the appended claims.

1. A graphical user interface for inputting symbols into a handheld mobile communication device having a reduced key keyboard comprising a plurality of multi-functional keys and corresponding indicia including keys associated with alphabetic characters corresponding to an array of letters A-Z defined with reference to a standard alphabetic format for arranging said letters on a regular keyboard and an overlaid numeric phone key arrangement, said plurality of keys associated with alphabetic characters numbering fewer than 26; the graphical user interface (GUI) comprising:
a plurality of views for displaying on a display of the device, each view representing said plurality of keys associated with the alphabetic characters and respective symbols associated with individual ones of said plurality of keys; and
a mapping component for selecting a symbol in response to a user input using a one of said plurality of keys associated with the alphabetic characters.

2. The graphical user interface of claim 1 wherein each of the plurality of views represent a look of the reduced key keyboard whereby to permit a user to visually map each key to its' associated symbol.

3. The graphical user interface of claim 1 wherein the symbols include punctuation symbols and wherein at least a portion of the punctuation symbols comprising most frequently used punctuation symbols are arranged among the plurality of views in priority to other of the symbols.

4. The graphical user interface of claim 1 wherein the symbols include symbols for addressing text messages and wherein the symbols for addressing text messages are arranged among the plurality of views in priority to other of the symbols.

5. The graphical user interface of claim 1 wherein logically related symbols are grouped among the plurality of views.

6. The graphical user interface of claim 5 wherein the logically related symbols are grouped in response to an expected frequency of use.

7. The graphical user interface of claim 6 wherein the logically related symbols include at least one of currency symbols and emoticons.

8. The graphical user interface of claim 7 wherein at least a portion of the currency symbols are arranged in a group on a first view of the plurality of views.

9. The graphical user interface of claim 1 wherein the symbols include a pair of parenthesis “(” and “)”, a pair of brackets “[” and “]” and a pair of braces “{” and “}”; and wherein the respective pairs are assigned to a same pair of keys selected from said plurality of keys among the plurality of views.

10. The graphical user interface of claim 9 wherein the same pair of keys is selected in response to the general position of said pairs of parenthesis, brackets and braces in the regular keyboard.

11. The graphical user interface of claim 1 wherein at least a portion of the symbols each have a respective association with a number key of the regular keyboard and wherein said portion of the symbols are arranged in association with keys selected from the plurality of keys representing like number keys.

12. The graphical user interface of claim 1 wherein a one of said plurality of keys is defined as a function key for moving among the plurality of views and wherein the mapping component is adapted to display a one of the plurality views in response to a user input using the function key for moving.

13. The graphical user interface of claim 12 wherein each of the plurality of views includes a representation of the function key whereby to indicate to a user how to move among the plurality of views.

14. The graphical user interface of claim 1 wherein the GUI is adapted to respond to one or more input devices of the mobile communication device for moving a focus about a view to select a symbol.

15. The graphical user interface of claim 1 wherein the symbols include emoticons comprising at least two characters for inputting.

16. The graphical user interface of claim 1 in which the standard alphabetic format for arranging said letters on a regular keyboard is a QWERTY standard.

17. A handheld mobile communication device comprising:
a reduced key keyboard comprising a plurality of multi-functional keys and corresponding indicia including keys associated with alphabetic characters corresponding to an array of letters A-Z defined with reference to a standard alphabetic format for arranging said letters on a regular keyboard and an overlaid numeric phone key arrangement, said plurality of keys associated with alphabetic characters numbering fewer than 26; and
a graphical user interface (GUI) for inputting symbols into the handheld mobile communication device comprising:
a plurality of views for displaying on a display of the device, each view representing said plurality of keys associated with the alphabetic characters and respective symbols associated with individual ones of said plurality of keys; and
a mapping component for selecting a symbol in response to a user input using a one of said plurality of keys associated with the alphabetic characters.

18. The device of claim 17 wherein logically related symbol are grouped and distributed among the plurality of views in response to an expected frequency of use.

19. A method for inputting symbols into a handheld mobile communication device having a reduced key keyboard comprising a plurality of multi-functional keys and corresponding indicia including keys associated with alphabetic characters corresponding to an array of letters A-Z defined with reference to a standard alphabetic format for arranging said letters on a regular keyboard and an overlaid numeric phone key arrangement, said plurality of keys associated with alphabetic characters numbering fewer than 26, the method comprising:
providing a plurality of views for displaying on a display of the device, each view representing said plurality of keys associated with the alphabetic characters and respective symbols associated with individual ones of said plurality of keys;
providing a mapping component for selecting a symbol in response to a user input using a one of said plurality of keys associated with the alphabetic characters; and
displaying the plurality of views and selecting a symbol in response to user input received to input into said device.

20. The method of claim 19 wherein providing a plurality of views comprises defining said views to represent a look of the reduced-key keyboard whereby to permit a user to visually map each key to its' associated symbol.

21. The method of claim 19 wherein the symbols include punctuation symbols and wherein providing a plurality of views comprises defining said views such that at least a portion of the punctuation symbols comprising most frequently used punctuation symbols are arranged among the plurality of views in priority to other of the symbols.

22. The method of claim 19 wherein the symbols include symbols for addressing text messages and wherein providing a plurality of views comprises defining said views such that the symbols for addressing text messages are arranged among the plurality of views in priority to other of the symbols.

23. The method of claim 19 wherein providing a plurality of views comprises defining said views such that logically related symbols are grouped among the plurality of views.

24. The method of claim 23 wherein the logically related symbols are grouped in response to an expected frequency of use.

25. The method of claim 24 wherein the logically related symbols include at least one of currency symbols and emoticons.

26. The method of claim 25 wherein at least a portion of the currency symbols are arranged in a group on a first view of the plurality of views.

27. The method of claim 19 wherein the symbols include a pair of parenthesis “(” and “)”, a pair of brackets “[” and “]” and a pair of braces “{” and “}”; and wherein providing a plurality of views comprises defining said views such that the respective pairs are assigned to a same pair of keys selected from said plurality of keys among the plurality of views.

28. The method of claim 27 wherein the same pair of keys is selected in response to the general position of said pairs of parenthesis, brackets and braces in the regular keyboard.

29. The method of claim 19 wherein at least a portion of the symbols each have a respective association with a number key of the regular keyboard and wherein providing a plurality of views comprises defining said views such that the portion of the symbols are arranged in association with keys selected from the plurality of keys representing like number keys.

30. The method of claim 19 wherein a one of said plurality of keys is defined as a function key for moving among the plurality of views and wherein the mapping component is adapted to display a one of the plurality views in response to a user input using the function key for moving.

31. The method of claim 30 wherein providing a plurality of views comprises defining each of the plurality of views to include a representation of the function key whereby to indicate to a user how to move among the plurality of views.

32. The method of claim 19 wherein said displaying and selecting comprises responding to one or more input devices of the mobile communication device for moving a focus about said views to select a symbol.

33. The method of claim 19 wherein the symbols include emoticons comprising at least two characters for inputting.

34. The method of claim 19 in which the standard alphabetic format for arranging said letters on a regular keyboard is a QWERTY standard.

35. A computer program product for directing a handheld mobile communication device having a reduced key keyboard comprising a plurality of multi-functional keys and corresponding indicia including keys associated with alphabetic characters corresponding to an array of letters A-Z defined with reference to a standard alphabetic format for arranging said letters on a regular keyboard and an overlaid numeric phone key arrangement, said plurality of keys associated with alphabetic characters numbering fewer than 26, said product comprising:
a computer usable program medium embodying one or more instructions executable by the device to provide a graphical user interface (GUI) for inputting symbols into the handheld mobile communication device, said one or more instructions comprising:
instructions defining a plurality of views for displaying on a display of the device, each view representing said plurality of keys associated with the alphabetic characters and respective symbols associated with individual ones of said plurality of keys; and
instructions defining a mapping component for selecting a symbol in response to a user input using a one of said plurality of keys associated with the alphabetic characters.
